(19) United States
(12) Patent Application Publication
(10) Pub. No.: US 2013/0195088 A1
(43) Pub. Date: Aug. 1, 2013

(54) MOBILE HOTSPOT DEVICE AND BATTERY

(71) Applicants: Kwun Ho, San Diego, CA (US); John Jiang, San Diego, CA (US); Pedro Gutierrez, San Diego, CA (US); Tony Ornelas, San Diego, CA (US); Mahsa Nakhjiri, San Diego, CA (US)

(72) Inventors: Kwun Ho, San Diego, CA (US); John Jiang, San Diego, CA (US); Pedro Gutierrez, San Diego, CA (US); Tony Ornelas, San Diego, CA (US); Mahsa Nakhjiri, San Diego, CA (US)

(73) Assignee: NOVATEL WIRELESS, INC., San Diego, CA (US)

(21) Appl. No.: 13/361,842

(22) Filed: Jan. 30, 2012

(51) Int. Cl. H04W 84/12; G06F 3/041; H04W 76/00

(52) U.S. Cl. 370/338; 370/328

(57) ABSTRACT

A mobile hotspot device may be used to interface one or more host computing devices with a wireless wide area network. The mobile hotspot device is powered by a high-capacity lithium ion (Li-Ion) cylindrical battery pack(s) and has a small, pen-like form factor. Use of the Li-Ion cylindrical battery pack(s) improves mobile hotspot device talk time over prismatic battery cell technology, as well as avoids premature device/modem shutdown experienced when a prismatic battery cell is proximate to a printed circuit assembly of the mobile hotspot device. Additionally still, Li-Ion cylindrical battery pack(s) avoid negatively impacting volume capacity of the mobile hotspot device. Further still, use of the Li-Ion cylindrical battery pack(s) allows for unique, interactive information display, as well as evolutionary mobile hotspot device design and form factors.

### TECHNICAL FIELD

The present application relates generally to portable communications devices, and more particularly, to battery powered mobile hotspot systems and methods.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Existing wireless modems may be inserted, or otherwise interfaced with a computer to enable data communication over a wireless Wide Area Network (WAN) such as a cellular type network. Early versions of such wireless modems were embodied as personal computer (PC) cards that had connectors that complied with the Personal Computer Memory Card International Association (PCMCIA) standard. Such cards were inserted into a corresponding PCMCIA slot built into a PC, such as a laptop PC. Newer implementations of such wireless modems include Universal Serial Bus (USB) connectors for interfacing with a computer. Such modems allow access to the Internet or World Wide Web (WWW), even where no wired network connection exists, and are most often interfaced with a laptop or other portable computing device.

FIG. 1A illustrates a wireless modem 100 through which a data connection can be established over a WAN. Wireless modem 100 may be a USB stick-type wireless modem, as discussed above, having a USB connector 110 through which the wireless modem 100 can interface with a PC.

FIG. 1B illustrates a wireless system including the wireless modem 100 of FIG. 1A connected to a host computing device 150, and enabling data communications. A user may insert, connect, or otherwise interface the wireless modem 100 with the host computing device 160 via, e.g., a USB interface 115 (which may include the USB connector 110). The wireless modem 100 may further comprise a controller/processor 120 and memory unit 130, as well as a radio portion 140 for sending/receiving data via an antenna module 150. After the wireless modem 100 is interfaced with (also referred to as being tethered to) the host computing device 160, the wireless modem 100 may then establish a data connection between a base station 170, associated with, e.g., a cellular type network, and the host computing device 160. The wireless modem 100 and the base station 170 can communicate via wireless signals 180. In particular, a connection manager operatively running on the host computing device 160 may be launched. The connection manager may display whether a network, i.e., the WAN, is available. If it is, the user can select the available network, which in turn causes a Point-to-Point Protocol (PPP) connection to be established between the base station 170 and the host computing device 160 via the wireless modem 100.

### SUMMARY

Various aspects of examples of the invention are set out in the claims.

According to a first aspect, an apparatus comprises at least one processor and at least one memory. The at least one memory includes computer program code, the at least one memory and the computer program code configured to, with the at least one processor, cause the apparatus to perform at least the following: establish, utilizing a first radio module, a connection with a base station associated with a first wireless communications network to activate the first wireless communications network; establish, utilizing a second radio module, a connection with at least one host computing device to establish a second wireless communications network; and provide the at least one host computing device access to a data network via the first wireless communications network, wherein the apparatus is powered utilizing a high-capacity lithium-ion cynlindrical battery cell.

According to a second aspect, a system for providing at least one host computing device access to a data network comprises: at least one host computing device; a base station associated with a first wireless communications network; and a mobile hotspot device. The mobile hotspot device comprises: a first radio module and a second radio module, the first radio module operating to connect the mobile hotspot device to the base station to activate the first wireless communications network; a second radio module operating to connect to the at least one host computing device to establish a second wireless communications network; a high capacity lithium-ion cylindrical battery cell configured to power the mobile hotspot device; a data interface element; a display element operating to display at least one informational element associated with operation of at least one aspect of the mobile hotspot device; and at least one processor and at least one memory including computer program code, the at least one memory and the computer program code configured to, with the at least one processor, control operation of the mobile hotspot device.

### BRIEF DESCRIPTION OF THE DRAWINGS

For a more complete understanding of example embodiments, reference is now made to the following descriptions taken in connection with the accompanying drawings in which:

FIG. 1A illustrates a conventional USB stick-type wireless modem;

FIG. 1B is a schematic representation of the USB stick-type wireless modem of FIG. 1A, and system architecture in which the USB stick-type wireless modem is utilized;

FIGS. 2A and 2b are perspective views of a mobile hotspot device configured in accordance with one embodiment of the present invention;

FIGS. 3A and 3B are perspective views of a mobile hotspot device configured in accordance with another embodiment of the present invention;

FIG. 4 is a schematic representation of a mobile hotspot device configured in accordance with one embodiment of the present invention, and system archictecture in which the mobile hotspot device is utilized;

### DETAILED DESCRIPTION OF THE DRAWINGS

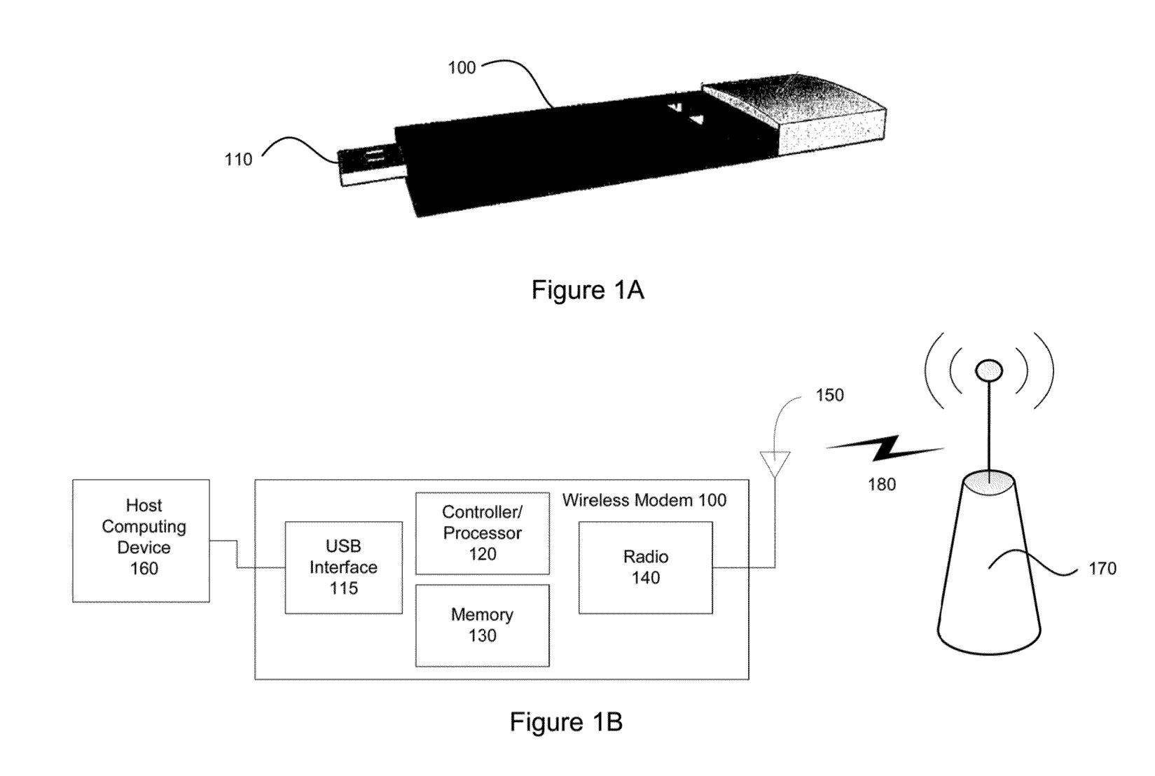

Example embodiments and their potential advantages are understood by referring to FIGS. 1-4 of the drawings.

Various embodiments are directed to mobile hotspot devices used to interface one or more host computing devices or LAN client devices with a wireless WAN, where the mobile hotspot devices are powered by a high-capacity lithium ion (Li-Ion) cylindrical battery pack(s) and have a small, pen-like form factor. For example, the WAN can be configured to implement one of the Third Generation (3G) protocols, such as EDGE, CDMA2000, or the Universal Mobile Telecommunications System (UMTS) protocols, High Speed Packet Access (HSPA) or HSPA+ protocols, Long Term Evolution (LTE) protocols, Evolution Data Optimization (EV-DO) rev. A (DOrA), WiMAX, or other newer 4G protocols. The one or more host computing devices interface with the the mobile hotspot device over, e.g., a wireless Local Area Network (LAN) such as a WiFi network, wireless USB network, ultrawideband network, or a Zigbee network. It should be noted that the descriptions and embodiments provided herein are not intended to limit the various embodiments to particular standards or architectures. Rather, the embodiments are being provided by way of example only.

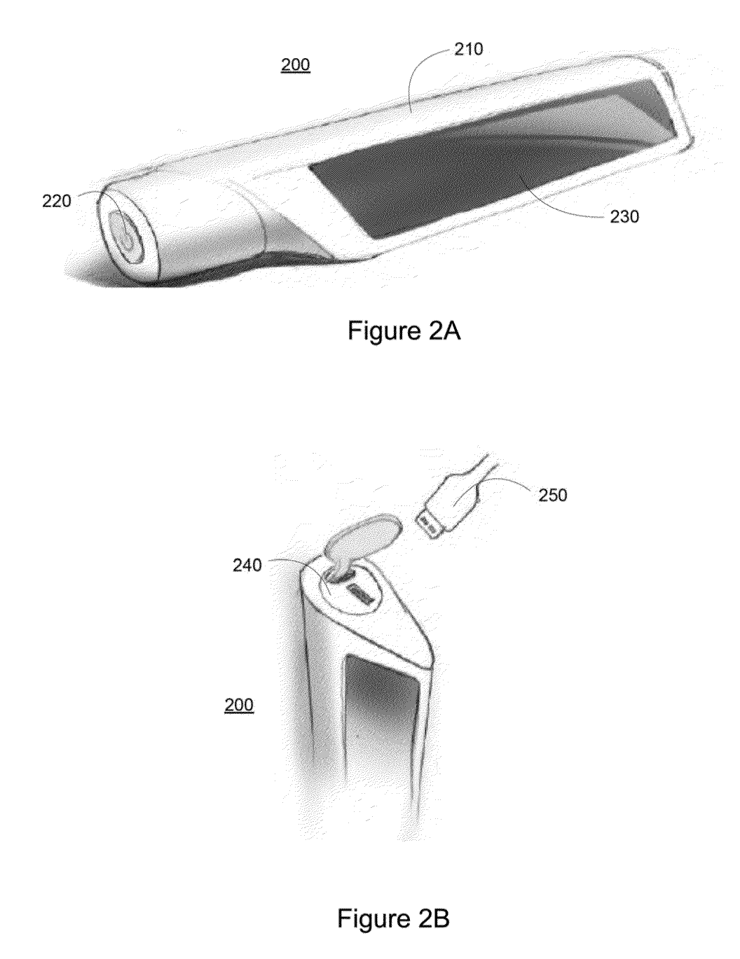

FIGS. 2A and 2B illustrate an exemplary mobile hotspot device 200 in accordance with one embodiment of the present invention. FIG. 2A is a first perspective view of the mobile hotspot device 200. The mobile hotspot device 200 comprises a housing 210, a power on/off button 220, and a display 230. The display 230 may be any implemented using an appropriate display technology, such as an organic light emitting diode (OLED) display, whether passive-matrix (PMOLED) or active-matrix (AMOLED), standard LED, etc. The display 230 allows for user one or more user interactions e.g., allowing a user to receive and view messages/notifications, such as service provider or network messages/notifications. The display 230 further allows for vendor and/or manufacturer branding of the mobile hotspot device, as well as allowing various status notifications to be displayed to a user, such as signal strength, connectivity status, battery life, power, etc., indications.

FIG. 2B illustrates a second perspective view of the mobile hotspot device 200. The mobile hotspot device 200 may, but need not necessarily include a mechanism for interfacing with the mobile hotspot device 200. For example, and as illustrated in FIG. 2B, a USB port 240 is included in the mobile hotspot device 200, where a USB cable 250 may be inserted into. The USB port 240 (or other interface) may be utilized in recharging a battery pack of the mobile hotspot device 200, (as will be discussed in greater detail), and or for, e.g., configuring the mobile hotspot device 200 via a computer, downloading data, etc.

The housing 210 of the mobile hotspot device 200 is shown to be pen-like or somewhat cylindrical in shape. As indicated above, various embodiments of the present invention are powered by high-capacity Li-Ion cylindrical battery packs. Conventional mobile hotspot devices are generally powered by pristmatic batteries. However, even state-of-the-art prismatic battery cell technology often results in limited mobile hotspot talk time (forcing users to often be physically connected to a power source), as well as premature device/modem shutdown depending on the location of the prismatic battery cell relative to the printed circuit assembly of the mobile hotspot device. Additionally still, prismatic battery cells are known to negatively impact a mobile hotspot device's volume capacity. Thus, the use of Li-Ion cylindrical battery technology, various embodiments of the present invention may provide substantially increased talk time for the mobile hotspot device as compared to conventional mobile hotspot devices, and allow for unique ID'ing/evolutionary designs and form factors.

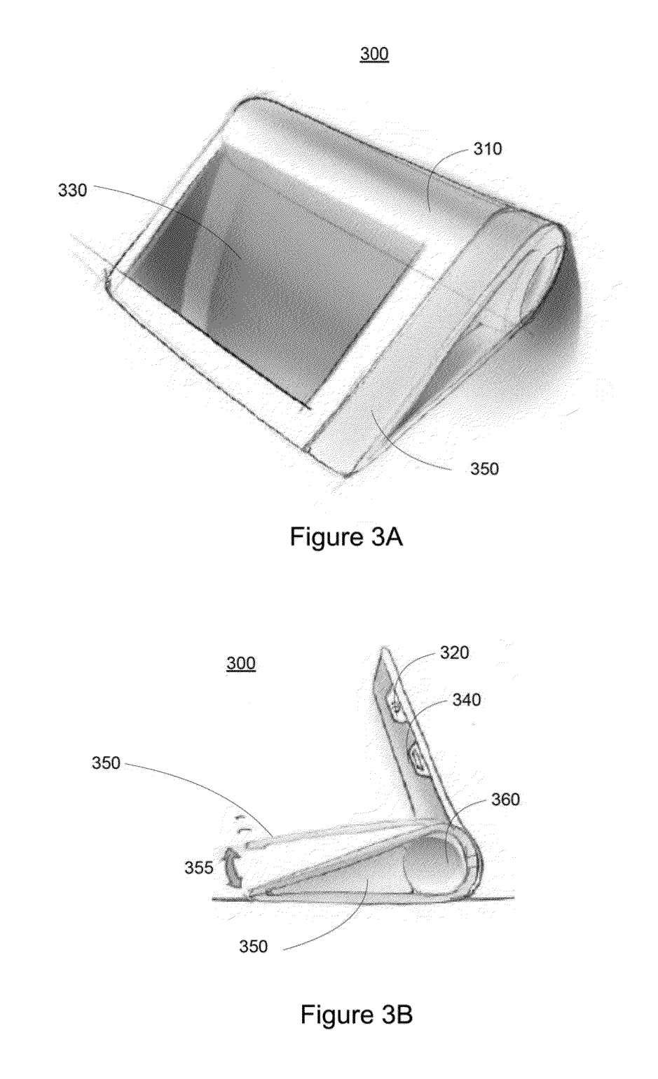

FIGS. 3A and 3B illustrate an exemplary mobile hotspot device 300 in accordance with another embodiment of the present invention. FIG. 3A is a first perspective view of the mobile hotspot device 300, and FIG. 3B illustrates a second perspective view of the mobile hotspot device 300. The mobile hotspot device 300 comprises a housing 310, a power on/off button 320, and a display 330. The display 330 may be any implemented using an appropriate display technology, such as an organic light emitting diode (OLED) display, whether passive-matrix (PMOLED) or active-matrix (AMOLED), standard LED, etc.

Like the display 230 of the mobile device 200, the display 330 allows for user one or more user interactions, e.g., allowing a user to receive and view messages/notifications, such as service provider or network messages/notifications. The display 230 further allows for vendor and/or manufacturer branding of the mobile hotspot device, as well as allowing various status notifications to be displayed to a user, such as signal strength, connectivity status, battery life, power, etc., indications. However, due to the larger area of the display 330, user interaction with the display 330 may be effectuated via touchscreen interaction. That is, the display 330 may have a unique “carousel” of icons facilitating gesture-based scrolling, tapping to select/enter desired actions, etc.

Further still, the mobile hotspot device 300 may include a “kickstand” 350 that allows the mobile hotspot device 300 to be oriented in a variety of different positions. As illustrated in FIG. 3B, the kickstand 350 is configured to move relative to and, e.g., rotably, around battery cell compartment 360 in the direction indicated by arrow 355. Alternatively, the mobile hotspot device 300 may be configured such that the display portion of the mobile device 300 substantially rotates relative to/around the battery cell compartment 360, again allowing the mobile hotspot device 300 to be oriented in different positions.

Like the mobile hotspot device 200 illustrated in FIGS. 2A and 2B, the mobile hotspot device 300 may, but need not necessarily include a mechanism for interfacing with the mobile hotspot device 300. For example, and as illustrated in FIG. 3B, a USB port 340 is included in the mobile hotspot device 300. The USB port 340 (or other interface) may be utilized in recharging a battery pack (again preferably a Li-Ion cynlindrical battery cell) of the mobile hotspot device 300, and or for, e.g., configuring the mobile hotspot device 300 via a computer, downloading data, etc.

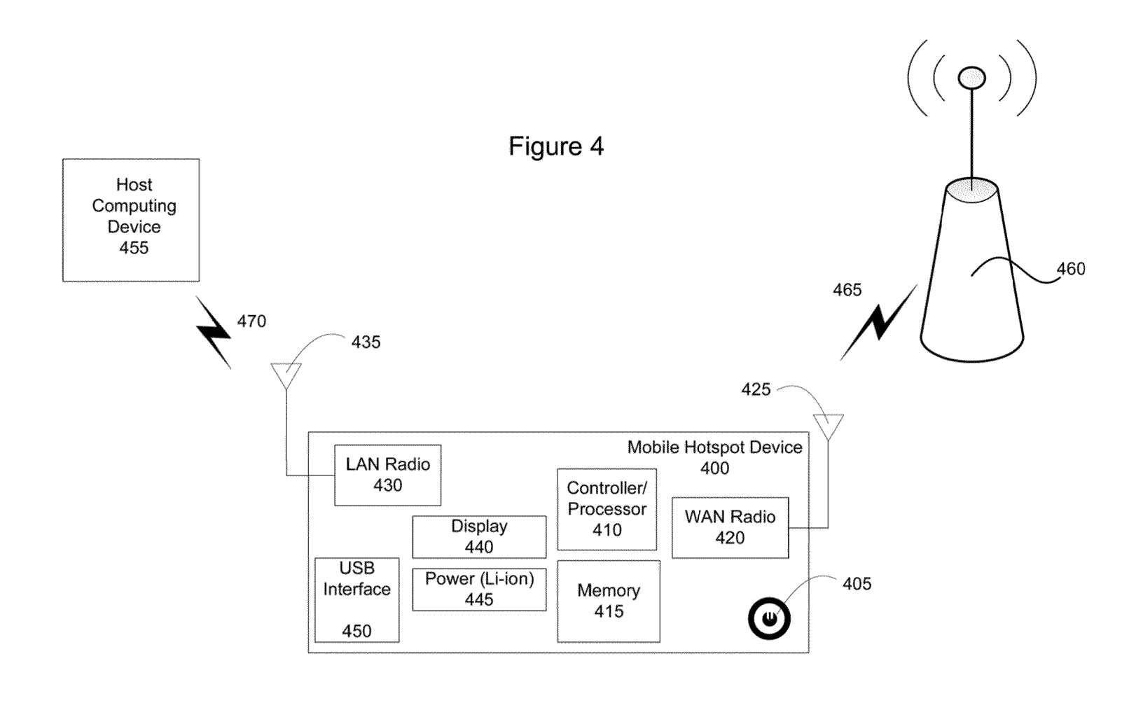

FIG. 4 illustrates an exemplary system archictecture in which a mobile hotspot device 400 may be utilized in accordance with various embodiments of the present invention. The mobile hotspot device 400 may include a controller/processor 410 and memory unit 415. Controller/processor 410 may comprise one or more processing cores such as a digital signal processing core, a microprocessing core, math-coprocessors, etc. The memory unit 415 may comprise one or more types of memory, including but not limited to volatile (for storing “transient” data) as well as non-volatile (for storing, e.g., computer program code for running/operating the controller/processor 410) memory. Examples of volative memory include, but are not limited to, Dynamic Random Access Memory (DRAM) and static random access memory (SRAM). Examples of non-volatile memory include, but are not limited to, Programmable ROM (PROM), Erasable PROMs (EPROM), Electrically erasable PROM (EEPROM), Flash memory, or some combination thereof. In certain embodiments, some portion or even all of non-volatile memory, volatile memory, or both can be included with the controller/processor 410.

The mobile hotspot device 400 of FIG. 4 may further include a WAN radio 420 and a LAN radio 430. The WAN radio 420 is configured to allow the mobile hotspot device 400 to access a WAN by communicating with a base station 460 associated with the WAN through wireless signals 465 transmitted and received via antenna 425. Wireless signals 465 are appropriate to the communication protocol(s) associated with the WAN. The LAN radio 430 allows the mobile hotspot device 400 to wirelessly communicate/interact with one or more host computing devices, such as host computing device 455. That is, LAN radio 430 exchanges wireless signals 470 (e.g., TCP/IP over WiFi) with the host computing device 455 via antenna 435. Wireless signals 465 and 475 may be the same or different according to the relevant communication protocol(s) utilized by the LAN and WAN.

The controller/processor 410 may further serve as a processing backend for both of the WAN radio 420 and the LAN radio 430. Alternatively, separate processing circuitry (not shown) may be included for each of the LAN function and the WAN function. Instructions stored in the memory unit 415 may be used by the processor 502 to control the operation of the mobile hotspot device 400, which includes operation of the WAN radio 420 and the LAN radio 430, as well as for bridging communications between the WAN basestation 460 and the one or more host computing device(s) 455 and configuring the mobile hotspot device 400.

The mobile hotspot device 400 further comprises a power button 405, that when actuated powers on or off the mobile hotspot device 400, depending on its state when the power button 405 is actuated. As previously described, a Li-Ion cylindrical battery cell 445 may be used as the power source for the mobile hotspot device 400 (which can be configured to be recharged via a USB port/interface 450 that may also act as an additional interface for the mobile hotspot device 400).

Upon powering up the mobile hotspot device 400, a connection with the base station 460 is established and the WAN is activated. The mobile hotspot device 400 is then able to route data from the one or more host computing device(s) 455 to the WAN associated with the base station 460. In particular, the mobile hotspot device 400 is capable of automatically establishing a data connection, e.g., a PPP connection, as previously described, with the base station 460. Thereafter, or substantially simultaneously, the mobile hotspot device 400 enables the LAN, thus acting as a wireless LAN access point.

The one or more host computing device(s) 455 may then access provided services, such as, e.g., Internet access, by way of the mobile hotspot device 400. It should be noted that certain authentication/authorization procedures may be executed before allowing Internet access. A user may complete such authentication/authorization procedures via, e.g., the host computing device 455 or the touchscreen display 440.

It should be noted that FIG. 4 illustrates various components, elements, and/or modules that may comprise the mobile hotspot device 400 in accordance with one or more embodiments. However, it should be understood that more or less components, elements, and/or modules can be included. That is, the embodiment illustrated in FIG. 4 of the mobile hotspot device 400 is not intended to exhaustively show all components, but rather is provided by way of example to illustrate certain components in relation to the systems and methods described herein. Moreover, such components, elements, and/or modules may be implemented via multiple components such as multiple integrated circuits, discrete device, or both, and can be packaged in a single package or in multiple packages.

It should be further noted that other embodiments contemplated by the present invention may incorporate more or less physical and/or interactive features described herein, and may configure a mobile hotspot device in various manners, e.g., implementing one or more displays in another location/position, positioning a power button/interface port (e.g., USB port) in other locations, etc. It should be further noted that a Li-Ion cylindrical battery cell utilized in various embodiments in the present invention may be user-replaceable. That is, a battery cell compartment, such as battery cell compartment 360 illustrated in FIG. 3 may have a removable/opening door (not illustrated).

Various embodiments of the present invention may be implemented in a system having multiple communication devices that can communicate through one or more networks. The system may comprise any combination of wired or wireless networks such as a mobile telephone network, a wireless Local Area Network (LAN), a Bluetooth personal area network, an Ethernet LAN, a wide area network, the Internet, etc.

Communication devices may include a mobile telephone, a personal digital assistant (PDA), a notebook computer, etc. The communication devices may be located in a mode of transportation such as an automobile.

The communication devices may communicate using various transmission technologies such as Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc.

An electronic device in accordance with embodiments of the present invention may include a display, an input mechanism, a microphone, an ear-piece, a battery, and an antenna. The device may further include radio interface circuitry, codec circuitry, a controller/CPU/processor and a memory.

Various embodiments described herein are described in the general context of method steps or processes, which may be implemented in one embodiment by a software program product or component, embodied in a machine-readable medium, including executable instructions, such as program code, executed by entities in networked environments. Generally, program modules may include routines, programs, objects, components, data structures, etc. that perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various embodiments of the present invention can be accomplished with standard programming techniques with rule-based logic and other logic to accomplish various database searching steps or processes, correlation steps or processes, comparison steps or processes and decision steps or processes.

The foregoing description of various embodiments have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

What is claimed is:

1. An apparatus comprising:
at least one processor; and
at least one memory including computer program code, the at least one memory and the computer program code configured to, with the at least one processor, cause the apparatus to perform at least the following:
establish, utilizing a first radio module, a connection with a base station associated with a first wireless communications network to activate the first wireless communications network;
establish, utilizing a second radio module, a connection with at least one host computing device to establish a second wireless communications network; and
provide the at least one host computing device access to a data network via the first wireless communications network, wherein the apparatus is powered utilizing a high-capacity lithium-ion cynlindrical battery cell.

2. The apparatus of claim 1, wherein the first wireless communications network comprises a wide area network.

3. The apparatus of claim 1, wherein the second wireless communications network comprises a wireless local area network.

4. The apparatus of claim 1, wherein the data network comprises the Internet.

5. The apparatus of claim further comprising, a display element.

6. The apparatus of claim 5, wherein the display element comprises a touchscreen light emitting diode display.

7. The apparatus of claim 1 further comprising, a housing, the housing including a substantially cynlindrical compartment for encapsulating the high-capacity lithium-ion cynlindrical battery cell.

8. The apparatus of claim 7, wherein the housing further comprises an actuating arm movable about the substantially cylindrical compartment providing a plurality of viewing angles for the apparatus.

9. The apparatus of claim 1 further comprising, a user-accessible data interface.

10. The apparatus of claim 1, wherein the user-accessible data interface comprises a universal serial bus port.

11. A system for providing at least one host computing device access to a data network comprising:
at least one host computing device;
a base station associated with a first wireless communications network; and
a mobile hotspot device comprising:
a first radio module and a second radio module, the first radio module operating to connect the mobile hotspot device to the base station to activate the first wireless communications network;
a second radio module operating to connect to the at least one host computing device to establish a second wireless communications network;
a high capacity lithium-ion cylindrical battery cell configured to power the mobile hotspot device;
a data interface element;
a display element operating to display at least one informational element associated with operation of at least one aspect of the mobile hotspot device; and
at least one processor and at least one memory including computer program code, the at least one memory and the computer program code configured to, with the at least one processor, control operation of the mobile hotspot device.

12. The system of claim 11, wherein the first wireless communications network comprises a wide area network.

13. The system of claim 11, wherein the second wireless communications network comprises a wireless local area network.

14. The system of claim 11, wherein the data network comprises the Internet.

15. The system of claim 11, wherein the display element comprises a touchscreen light emitting diode display.

16. The system of claim 11, wherein the mobile hotspot device further comprises a housing, the housing including a substantially cynlindrical compartment for encapsulating the high-capacity lithium-ion cynlindrical battery cell.

17. The system of claim 16, wherein the housing further comprises an actuating arm movable about the substantially cylindrical compartment providing a plurality of viewing angles for the apparatus.

18. The system of claim 11 further comprising, a user-accessible data interface.

19. The system of claim 18, wherein the user-accessible data interface comprises a universal serial bus port.
